(19) United States
(12) Patent Application Publication
(10) Pub. No.: US 2011/0279221 A1
(43) Pub. Date: Nov. 17, 2011

(54) RESISTOR AND METHOD OF FORMING A RESISTOR

(75) Inventors: Hong-Bok WE, Yongin-si (KR); Won-Wook So, Hwasung-si (KR); Jong-Heum Park, Suwon-si (KR); Young-Kyu Park, Suwon (KR)

(73) Assignee: SAMSUNG ELECTRO-MECHANICS., LTD.

(21) Appl. No.: 12/892,519

(22) Filed: Sep. 28, 2010

(30) Foreign Application Priority Data
May 17, 2010 (KR) 10-2010-0046083

(51) Int. Cl. H01C 1/012; H01C 17/00

(52) U.S. Cl. 338/307; 29/610.1

(57) ABSTRACT

A resistor and a method of forming a resistor are disclosed. The method of forming a resistor in accordance with an embodiment of the present invention can include: providing an electric conductor having a resistance area in which a plurality of through-holes are formed; measuring a resistance value of the resistance area; and compensating the resistance value of the resistance area by selectively removing a portion connecting the plurality of through-holes. Since it is possible to compensate the resistance value precisely by simply removing a portion connecting through-holes, the resistance value can be readily compensated. Moreover, since most of the through-holes needed for the adjustment of the resistance value can be formed by a common process, the production cost for forming a precise resistor can be saved.

### CROSS-REFERENCE TO RELATED APPLICATIONS

This application claims the benefit of Korean Patent Application No. 10-2010-0046083, filed with the Korean Intellectual Property Office on May 17, 2010, the disclosure of which is incorporated herein by reference in its entirety.

### BACKGROUND

1. Technical Field

The present invention is related to a resistor and a method of forming a resistor.

2. Description of the Related Art

Mobile electronic devices commonly use a rechargeable battery, which utilizes a resistor as a sensor to measure the remaining battery power.

By adding the resistor used as a sensor, which is a resistor having a very low resistance value, to a battery circuit, variation in minute resistance value of the resistor can be measured to determine the remaining battery power.

However, the resistor used as a sensor is difficult and expensive to manufacture. In order to form a resistor having a very low resistance value, a plurality of slits are formed on the lateral side of a metal sheet for the adjustment of resistance value, but the deviation in the resistor depends too much on the precision of processing the slits. Moreover, in order to process the slits precisely, the metal sheet needs to be processed by high-cost equipment, such as a laser processing apparatus, thereby increasing the cost.

### SUMMARY

The present invention provides a resistor and a method of forming a resistor that have a very low resistance value, have little deviation in manufacturing and cost less.

An aspect of the present invention features a method of forming a resistor. The method of forming a resistor in accordance with an embodiment of the present invention can include: providing an electric conductor having a resistance area in which a plurality of through-holes are formed; measuring a resistance value of the resistance area; and compensating the resistance value of the resistance area by selectively removing a portion connecting the plurality of through-holes.

The plurality of through-holes can be arranged in a matrix format.

The plurality of through-holes can be formed by at least one selected from the group consisting of a punching process, an etching process, a drilling process and a laser process.

The method of forming a resistor in accordance with this embodiment can also include: stacking a solder resist layer on the electric conductor; and forming a pair of electrodes on either side of the resistance area.

Another aspect of the present invention features a resistor. The resistor in accordance with an embodiment of the present invention can include: an electric conductor having a resistance area in which a plurality of through-holes are formed; and a pair of electrodes formed in the electric conductor and disposed on either side of the resistance area.

The plurality of through-holes can be arranged in a matrix format.

A portion connecting the plurality of through-holes can be selectively removed.

### BRIEF DESCRIPTION OF THE DRAWINGS

FIG. 1 is a flow diagram illustrating a method of forming a resistor in accordance with an embodiment of the present invention.

FIG. 2 to FIG. 6 illustrate a method of forming a resistor in accordance with an embodiment of the present invention.

FIG. 6 and FIG. 7 illustrate a resistor in accordance with another embodiment of the present invention.

### DETAILED DESCRIPTION

Hereinafter, some embodiments of the present invention will be described with reference to the accompanying drawings.

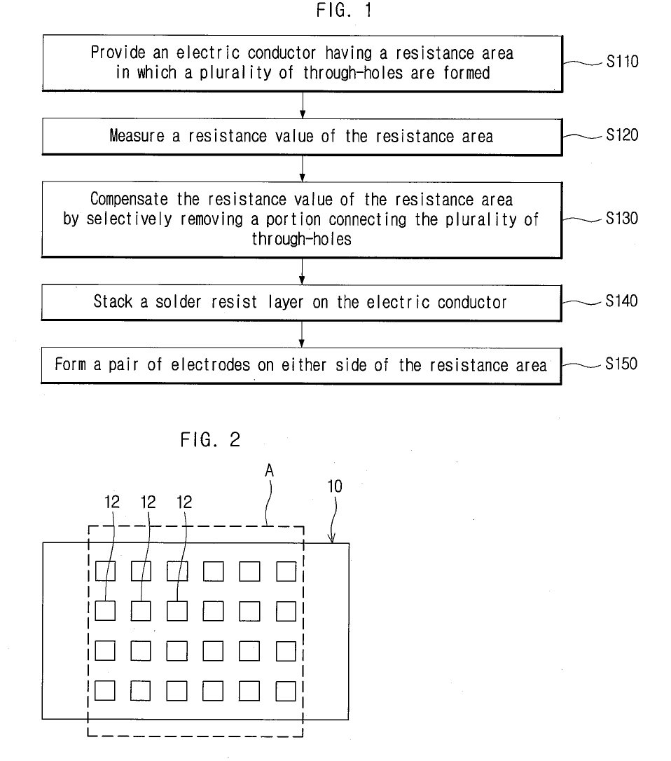

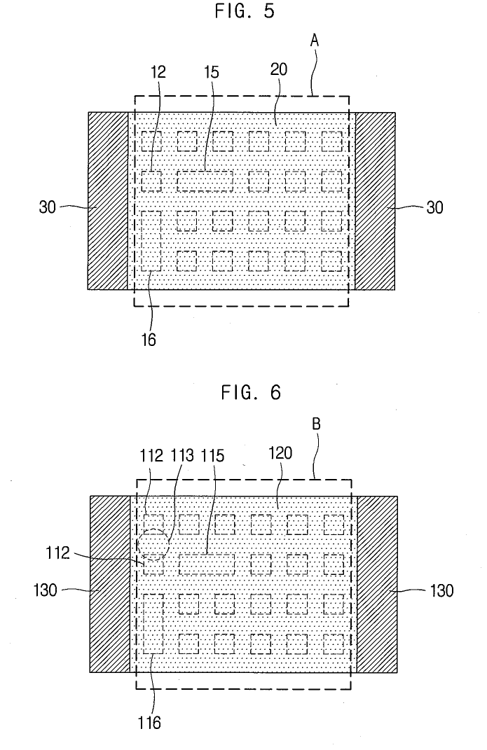

FIG. 1 is a flow diagram illustrating a method of forming a resistor in accordance with an embodiment of the present invention, and FIG. 2 to FIG. 6 illustrate a method of forming a resistor in accordance with an embodiment of the present invention.

The method of forming a resistor in accordance with an embodiment of the present invention includes providing an electric conductor (S110), measuring a resistance value (S12) and compensating the resistance value (S130).

In the step of providing an electric conductor (S110), an electric conductor 10, in which a plurality of through-holes 12 are formed, is provided. The area in which the plurality of through-holes 12 are formed becomes a resistance area A that forms electric resistance.

The electric conductor 10 is a material, such as metal, which has a high conductivity of electricity, that is, a material that has little electric resistance. However, once the through-holes 12 are formed in the electric conductor 10, the sectional area through which electricity is carried becomes reduced, and thus the resistance value increases although the increase in the resistance value is small. Therefore, by forming the through-holes 12 in the electric conductor 10, a resistor with a small resistance value can be formed.

As shown in FIG. 2, the present embodiment forms the resistance area A, in which the plurality of through-holes 12 are closely arranged in the electric conductor 10, in order to form a low-resistance resistor for a sensor. The number and size of through-holes 12 can be determined according to the resistance value of the resistor to be formed. Here, the shape of the through-holes 12 can be a circle, a polygon or any other various shapes.

Specifically, in the present embodiment, a multiple number of through-holes 12 can be formed simultaneously in the electric conductor 10, such as a metal plate, by a punching process using a plurality of needles. Moreover, the through-holes 12 can be formed by other various known methods (e.g., etching, drilling, laser processing, etc.).

Here, the resistance value of the resistance are A can be set to be a little lower than a targeted resistance value in the step of providing the electric conductor (S110) so that the resistance value of the electric conductor 10 can be additionally adjusted in the step of compensating the resistance value (S130), which will be described later.

In the step of measuring a resistance value (S120), it is measured whether the resistance value of the resistance area A is within a range of targeted resistance values. In the present embodiment, the resistance value between both end parts, on each of which an electrode 30 is formed, of the electric conductor 10 is measured.

In the step of compensating the resistance value (S130), the resistance value is compensated by removing some of the electric conductor 10 so that the resistance value of the resistance area A is within the range of targeted resistance values.

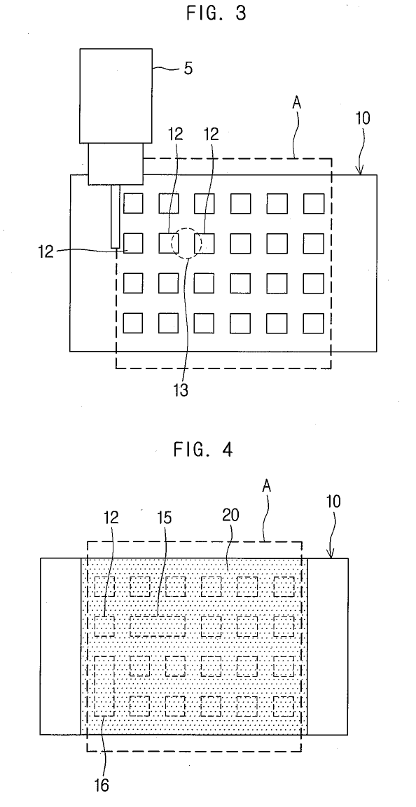

As shown in FIG. 3, in the present embodiment, the resistance value can be readily compensated by selectively removing a portion 13 connecting the plurality of through-holes 12. By removing the portion 13 connecting the through-holes 12 from the electric conductor 10 in which resistance is primarily formed by the plurality of through-holes 12, the sectional area through which electricity is carried is further reduced, thereby increasing the resistance. However, since electricity can be carried through a number of paths in the resistance area A in which the plurality of through-holes 12 are formed, that is, electricity can be carried through multiple paths simultaneously as if in a parallel circuit, the increase in resistance value is very small since most of the electricity can be carried through different paths even though one portion 13 connecting the plurality of through-holes 12 is removed.

Therefore, by removing the portion 13 connecting the plurality of through-holes 12 selectively, the resistance value can be precisely compensated. Here, for a more precise compensation of the resistance value, the portion 13 connecting the through-holes 12 can be removed in a precise size by use of a laser processing apparatus 5.

Particularly in this embodiment, the plurality of through-holes 12 are arranged in a matrix format, that is, a format having a series of rows and columns, and thus it is possible to provide a specific property when the portion 13 connecting the through-holes 12 is removed. Specifically, as shown in FIG. 4, a through-hole 15 extended in a parallel direction of electric flow has a different property from a through-hole 16 extended in a perpendicular direction of electric flow, and it is possible to adjust the resistance value more precisely using the above.

In the present embodiment, as shown in FIG. 4, a solder resist layer 20 can be formed on the electric conductor (S140) in order to prevent any foreign substance from being adhered to the resistor to change the resistance value or short-circuit the resistor. Moreover, in order to facilitate mounting of the electric conductor 10 on, for example, a printed circuit board, a pair of electrodes 30 can be formed in the electric conductor 10 on either side of the resistance area A (S150).

However, the method of forming the resistor in accordance with the present embodiment is not restricted to forming of a stand-alone resistor being separately mounted on a printed circuit board but can be applied in various forms of resistors, for example, a resistor pattern integrated on a wafer substrate.

As described above, the method of forming a resistor in accordance with the present embodiment can readily compensate the resistance value because it is possible to compensate the resistance value precisely by simply removing the portion 13 connecting the through-holes 12. Moreover, since most of the through-holes 12 needed for the adjustment of the resistance value can be formed by a common process, such as punching, the production cost for forming a precise resistor can be saved, thereby making it easier for mass production.

Hereinafter, the structure of a resistor in accordance with another embodiment of the present invention will be described.

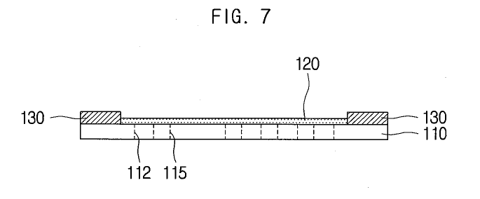

FIG. 6 and FIG. 7 illustrate a resistor in accordance with another embodiment of the present invention.

The resistor in accordance with the present embodiment includes an electric conductor 110 and electrodes 130.

The electric conductor 110 is a material, such as metal, which has a high conductivity of electricity, that is, a material that has little electric resistance. The electric conductor 110 of this embodiment is furnished with a resistance area B in which a plurality of through-holes 112 are formed.

Once the through-holes 112 are formed in the electric conductor 110, the sectional area through which electricity is carried becomes reduced, and thus the resistance value increases although the increase in the resistance value is small. Therefore, by forming the through-holes 112 in the electric conductor 110, a resistor with a small resistance value can be formed.

In the present embodiment, the resistance area B, in which the plurality of through-holes 112 are closely arranged in the electric conductor 110, are formed in order to form a low-resistance resistor for a sensor. The number and size of through-holes 112 can be determined according to the resistance value of the resistor to be formed. Here, the shape of the through-holes 112 can be a circle, a polygon or any other various shapes.

Specifically, in the present embodiment, a multiple number of through-holes 112 can be formed simultaneously in the electric conductor 110 by a punching process using a plurality of needles. Moreover, the through-holes 112 can be formed by other various known methods (e.g., lithographic process).

Moreover, the resistance value can be readily compensated by selectively removing a portion 113 connecting the plurality of through-holes 112. By removing the portion 113 connecting the through-holes 112 from the electric conductor 110 in which resistance is primarily formed by the plurality of through-holes 112, the sectional area through which electricity is carried is further reduced, thereby increasing the resistance. However, since electricity can be carried through a number of paths in the resistance area B in which the plurality of through-holes 112 are formed, that is, electricity can be carried through multiple paths simultaneously as if in a parallel circuit, the increase in resistance value is very small since most of the electricity can be carried through different paths even though one portion 113 connecting the plurality of through-holes 112 is removed.

Therefore, by removing the portion 113 connecting the plurality of through-holes 112 selectively, the resistance value can be precisely compensated.

Particularly in this embodiment, the plurality of through-holes 112 are arranged in a matrix format, that is, a format having a series of rows and columns, and thus it is possible to provide a specific property when the portion 113 connecting the through-holes 112 is removed. That is, a through-hole 115 extended in a parallel direction of electric flow has a different property from a through-hole 116 extended in a perpendicular direction of electric flow, and it is possible to adjust the resistance value more precisely using the above.

The electrodes 130, which electrically connects the resistor to, for example, a printed circuit board, facilitates mounting of the resistor. Specifically, a pair of electrodes 130 are disposed in the electric conductor 110 on either side of the resistance area B, and electric resistance is formed between the pair of electrodes 130 when electricity is conducted through the pair of electrodes 130.

As described above, the resistor in accordance with the present embodiment can readily compensate the resistance value because it is possible to compensate the resistance value precisely by simply removing the portion 113 connecting the through-holes 112. Moreover, since most of the through-holes 112 needed for the adjustment of the resistance value can be formed by a common process, such as punching, the production cost for forming a precise resistor can be saved, thereby making it easier for mass production.

Hitherto, some embodiments of the present invention have been described. However, it shall be appreciated by anyone ordinarily skilled in the art to which the present invention pertains that there can be a variety of permutations and modifications of the present invention without departing from the technical ideas and scopes of the present invention that are disclosed in the claims appended below.

A large number of embodiments in addition to the above-described embodiments are present within the claims of the present invention.

What is claimed is:

1. A method of forming a resistor, comprising:
providing an electric conductor having a resistance area in which a plurality of through-holes are formed;
measuring a resistance value of the resistance area; and
compensating the resistance value of the resistance area by selectively removing a portion connecting the plurality of through-holes.

2. The method of claim 1, wherein the plurality of through-holes are arranged in a matrix format.

3. The method of claim 1, wherein the plurality of through-holes are formed by at least one selected from the group consisting of a punching process, an etching process, a drilling process and a laser process.

4. The method of claim 1, further comprising:
stacking a solder resist layer on the electric conductor; and
forming a pair of electrodes on either side of the resistance area.

5. A resistor, comprising:
an electric conductor having a resistance area in which a plurality of through-holes are formed; and
a pair of electrodes formed in the electric conductor and disposed on either side of the resistance area.

6. The resistor of claim 5, wherein the plurality of through-holes are arranged in a matrix format.

7. The resistor of claim 6, wherein a portion connecting the plurality of through-holes is selectively removed.
